(19) United States
(12) Patent Application Publication
(10) Pub. No.: US 2004/0118169 A1
(43) Pub. Date: Jun. 24, 2004

(54) Locking sleeve for protecting gas line regulators

(76) Inventors: Gary Donath, San Luis Obispo, CA (US); Robert Turbow, San Luis Obispo, CA (US); Billy D. McMains, Big Bear Lake, CA (US)

Correspondence Address: MORGAN, LEWIS & BOCKIUS, LLP., 3300 HILLVIEW AVENUE, PALO ALTO, CA, 94304, US

(21) Appl. No.: 10/435,748

(22) Filed: May 9, 2003

Related U.S. Application Data
(60) Provisional application No. 60/436,188, filed on Dec. 24, 2002.

(51) Int. Cl. F16K 35/00; G05G 5/00; E05B 13/00

(52) U.S. Cl. 70/177; 70/180; 70/212

(57) ABSTRACT

A locking device to selectively lock a regulator. The device includes a hollow member, configured to receive a handle of a regulator, where the hollow member is closed on a first end and open on a second end. The second end is configured with at least three tabs extending along a longitudinal axis of the hollow member from the second end toward the first end where any two adjacent tabs define a slot configured to receive a gas line coupled to a regulator. Each tab defines a hole near the second end that is configured for receiving a locking mechanism.

This application claims priority to provisional application Serial No. 60/436,188 filed Dec. 24, 2002, the entire disclosure of which is incorporated by reference herein in its entirety.

### TECHNICAL FIELD OF THE INVENTION

Generally, this invention relates to a locking device for locking a regulator on a gas line. More specifically, the locking device of the present invention prevents access to gas regulators of the type used in the medical industry. The locking device also preferably provides for emergency access to the locked regulator.

### BACKGROUND OF THE INVENTION

Gas line couplings, fittings, valves, junctions, regulators, flow meters, or the like are used in many situations from gas welding facilities to hospitals. In some instances, such as in hospitals, operating rooms, doctors' offices, dentists' offices, and the like, the gas lines carry expensive or controlled substances, such as hydrogen, oxygen, nitrous oxide, or the like. In some hospital rooms patients, staff, visitors, and the like have been known to tamper with the gas regulators to improperly gain access to the substance.

Current devices that reduce tampering of regulators by providing a locking cover, have several limitations.

First, the current devices, once in a locked position, prevent all access to the regulator that is locked. An operator must possess a key to unlock the device to access the regulator. In a hospital setting, for example, this is inappropriate because there are often emergency conditions that require instant access to the locked regulator.

What is needed is a mechanism that allows an operator to gain immediate access to the valve in an emergency situation regardless of whether the operator possesses the proper key to the locking device.

Second, current devices are made from an opaque material, thereby preventing a user from seeing the regulator's current setting. The regulator may already be positioned in a setting where access to the regulator is not necessary. Yet, to determine this, the operator must unlock the device and remove it from the regulator, which is both time consuming and may be fatal in an emergency situation.

Therefore, a device that allows the operator to view the valve while the device is in its locked position would also be highly desirable.

### SUMMARY OF THE INVENTION

According to the invention there is provided a device for locking a regulator while providing the possibility of emergency access to the regulator regardless of the user's ability to unlock the device.

The present invention provides a locking device to selectively confine a regulator. The device includes a hollow member, configured to receive a handle of a regulator, where the hollow member is closed on a first end and open on a second end, and wherein the second end is configured with at least three tabs extending along a longitudinal axis of the hollow member from the second end toward the first end. At least two adjacent tabs define a slot configured to receive a gas line coupled to a regulator, and each tab defines a hole near the second end of the hollow member for receiving a locking mechanism that locks the locking device onto the regulator.

In this device, the tabs are made from a breakable material that can be broken by an adult near the hole that receives the locking mechanism.

In an alternative embodiment, there are at least four tabs extending along the longitudinal axis from the second end toward the first end of the hollow member. Any two adjacent tabs define a slot configured to receive the gas line, and each of the tabs define the hole near the second end of the hollow member configured for receiving the locking mechanism.

It is preferable that the hollow member be made from a transparent material, such that a user can view the regulator handle locked beneath the locking device when the locking device is locked onto the regulator.

Advantageously, a preferred embodiment of the locking device of the present invention addresses the drawbacks of current devices for guarding regulators because it provides for emergency access to the locked regulator regardless of whether the operator can properly operate the locking mechanism. In particular, the present device can be broken away, thereby freeing the regulator locked beneath. Furthermore, the present device can be reused multiple times following the breaking away of the device because there are selected regions that are intended to breakaway and free the regulator locked beneath while retaining the integrity of the remaining portions of the device.

### BRIEF DESCRIPTION OF THE DRAWINGS

The features and advantages of the present invention will be better understood by reference to the following detailed description, which should be read in conjunction with the accompanying drawings in which:

FIG. 1 is a three dimensional perspective view of an embodiment of the locking device of the present invention, in use, locked over a regulator;

FIG. 2 is a perspective view of an embodiment of the locking device of the present invention; and

FIG. 3 is a perspective view of another locking device according to another embodiment of the present invention.

Like reference numerals refer to corresponding parts throughout the several views of the drawings.

### DETAILED DESCRIPTION OF THE PREFERRED EMBODIMENT

The locking device of the present invention is generally constructed of a hollow member having a longitudinal axis. Generally, the locking device of the present invention is constructed to be fitted over flow meters, regulators, pressure regulators, gas or air line couplings, fittings, junctions, valves, or the like (hereinafter “regulator”). The hollow member is constructed such that it can be broken by an operator in an emergency situation to gain immediate access to the locked regulator. In use, the locking device of the present invention prevents senseless and unauthorized tampering with a regulator while providing immediate access to the regulator in an emergency situation.

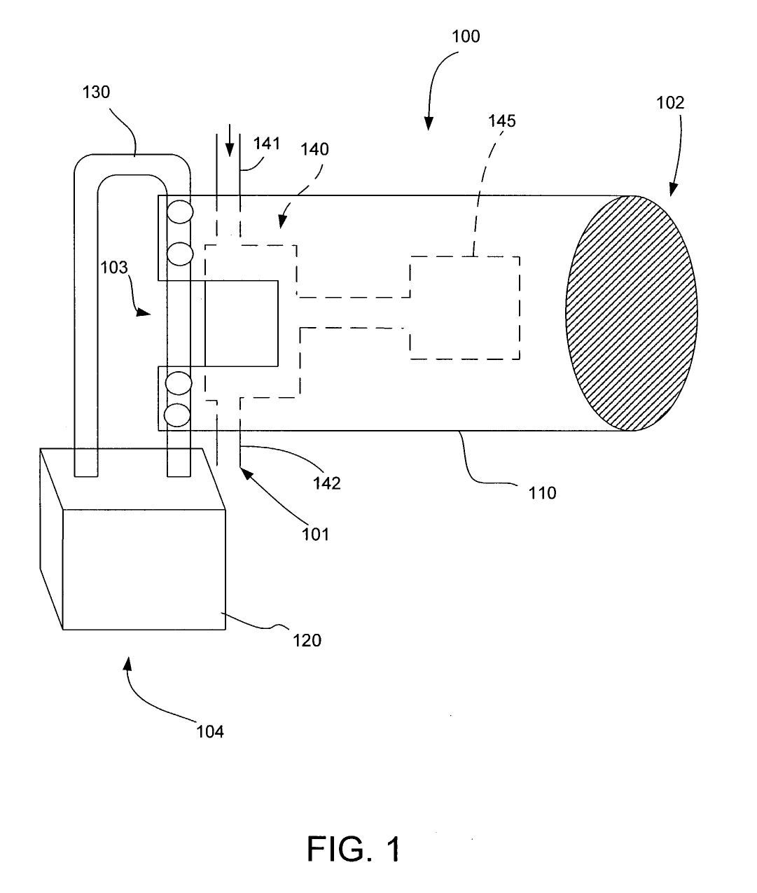

FIG. 1 is a three dimensional schematic view of a locking device 100 of the present invention, locked in place, over a regulator 140 coupled to a gas source (not shown), typically through a gas line 101. Gas in the gas line 101 enters a regulator 140 through an inlet line141 and exits the regulator 140 through an outlet line 142. The inlet gas is typically at a high pressure, as it typically flows to the regulator 140 from a high pressure gas source. The purpose of the regulator 140 is to allow an operator to turn on and off the gas flow in the outlet line 142 and control the pressure in the gas line 101 such that the pressure in the outlet line 142 is usable for a desired application. In use, the regulator 140 preferably has a handle 145 that an operator turns to adjust the pressure of the gas through the regulator 140.

Generally, locking device 100 is a hollow member 110 having a closed first end 102 and an open second end 103. In use, the open second end 103 is placed over the handle 145 of a regulator 140 and gas line 101; and the locking device 100 is positioned with the regulator handle 145 near the closed first end 102 of the hollow member 110. Once in position, a locking mechanism 104, preferably consisting of a lock 120 with a shackle 130, is used to lock the locking device 100 onto the regulator 140 such that the handle 145 may not be tampered with. The locking device 100 is constructed from a breakable material, such as a plastic substance that can be broken in selected locations (described below) by force generated by a user.

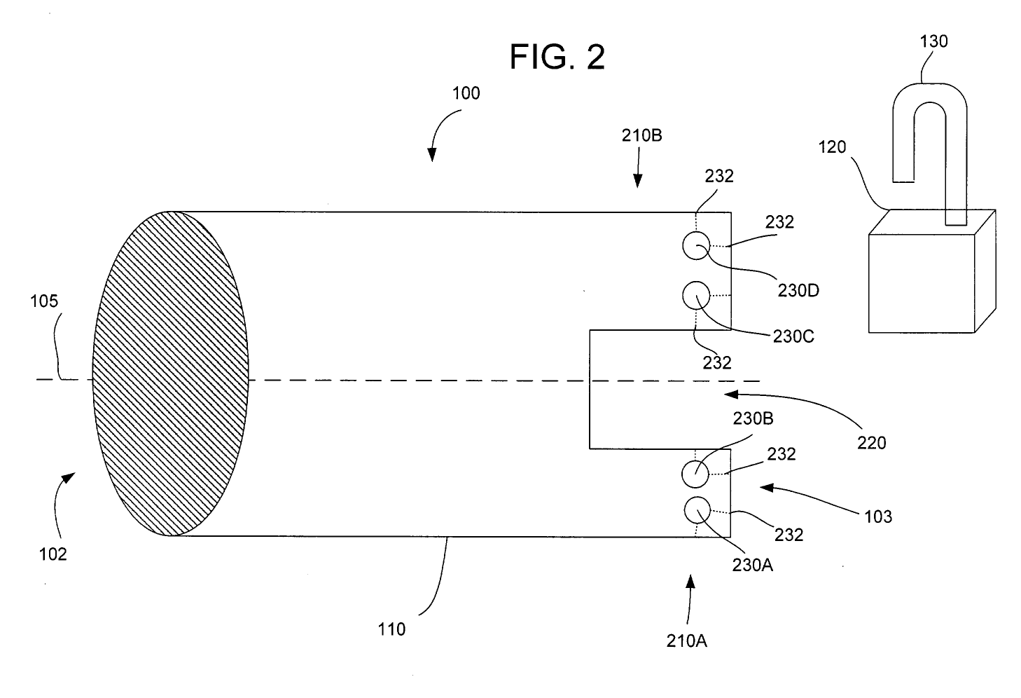

FIG. 2 is a three dimensional view of the locking device 100 removed from the regulator 140. The open second end 103 of the hollow member 110 has slots 220 extending from the open second end 103 of the hollow member 110 toward the closed first end 102 of the hollow member 110 along the hollow member's 110 longitudinal axis 105. The slots 220 are sized to receive the gas line 101 coupled to the regulator 140. Typical gas lines 101 received by the slots 220 include the inlet line 141 (FIG. 1), outlet line 142 (FIG. 1), and a line to a gauge (not shown) for determining the pressure in the gas line 101, or the like.

In a preferred embodiment there are three slots 220 in the hollow member 110 configured for receiving three gas lines 101, or the like, coupled to a regulator 140, or the like. In an alternative embodiment there are four slots 220 in the hollow member 110 for receiving four gas lines 101, or the like, coupled to a regulator 140, or the like. An example of a four line configuration is an inlet line, two outlet lines, and a line to a gauge.

Slots 220 are separated by tabs, two of which are shown in FIG. 2 as tabs 210A and 210B. The ends of the tabs 210A and 210B are defined by the open second end 103 of the hollow member 110, and the sides of the tabs 210A and 210B are defined by the longitudinal edges of the slots 220.

In a preferred embodiment there are three tabs defined by three slots 220 on the locking device 100. In use, in this configuration, the locking device 100 can receive a regulator 140 with a total of three inlet lines, outlet lines, gauges, or any such combination of lines. It should however be appreciated that any number of slots and tabs may be used.

The tabs are long enough that, when the locking device 100 is positioned over a regulator 140, the free end of the tabs 210A and 210B extend past the regulator 140 and gas lines 101 received by the slots 220.

The free end of the tabs 210A and 210B are configured to receive a locking mechanism 104. Near the end of each tab 210A and 210B there are a plurality of holes, four of which are shown as holes 230A, 230B, 230C, and 230D. The holes 230A, 230B, 230C, and 230D are preferably configured to receive a shackle 130 of a lock 120 for locking the hollow member 110 over the regulator 140.

In a preferred embodiment, a shackle 130 of a lock 120 is inserted through one of the holes 230A, 230B, 230C, or 230D near the end of the tab 210A or 210B and locked. With the shackle 130 in place, the locking device 100 is locked in place over the regulator 140 such that the handle 145 of the regulator 140 is not accessible.

In another embodiment of the invention, the shackle 130 is inserted through two holes to increase the force required to break the locking device 100 free from covering the regulator. In use, the shackle 130 is inserted through one hole, 230A, for example, in one tab, 210A, for example, and extends through another hole, 230D, for example, in another tab, 210B, for example. In this embodiment a greater amount of force is required to break the shackle 130 free from the locking device 100 than in the above embodiment where only one hole was used to lock the device in place. Therefore, the regulator 140 is more securely locked away from tampering.

If access to the regulator 140 is desired it can be gained in one of two ways. First, a user who possesses a key to the lock 120, can unlock the lock 120, and remove the shackle 130 from the hole 230A, 230B, 230C, or 230D through which it was secured, thereby freeing the locking device 100 from covering the regulator 140.

Alternatively, the shackle 130 can be broken free from the hollow member 110 as described below. In a preferred embodiment the holes 230A, 230B, 230C, and 230D have a line of perforations 232 extending from the open second end 103 to the hole 230A, 230B, 230C, and 230D, and from the edge of the tabs 210A and 210B that border the slots 220 to the hole 230A, 230B, 230C, and 230D. The perforations 232 are typically holes through or almost entirely through the hollow member 110 and are selectively spaced apart from each other such that a predetermined amount of torque, about the shackle 130, is required to break the remaining material in the region of the perforations 232. Preferably the predetermined torque can be generated by a normal adult given the dimensions of the lock 120 and shackle 130 employed as the locking mechanism 104 in the locking device 100. In use, the perforations 232 limit the breaking away of the hollow member 110 to the region of the perforations 232 around the hole through which the shackle 130 was engaged. As a result, neighboring holes are preserved for reuse of the locking device 100 after an operator breaks away the shackle 130 from one of holes 230A, 230B, 230C, or 230D.

Thus, after one or more holes are broken to allow the locking device to be removed from the handle, the user simply selects another hole 230A, 230B, 230C, or 230D or set of holes through which to insert the shackle 130 for a second locking of the locking device 100 over a regulator 140.

In an alternate embodiment, the tab 210A or 210B is configured to break, thereby releasing the locking device 100 from its locked position over the regulator 140.

It is preferable that the closed first end 102 be transparent (FIG. 2). The transparent closed first end 102 can be constructed from glass, clear plastic, such as plexi-glass, or the like. In use, the transparent closed first end 102 of the hollow member 110 allows a user to view the position of the regulator handle 145 to verify if it is already in a desired position, thereby not requiring the locking device to be unlocked or holes to be broken to access the regulator 140.

In an alternative embodiment a portion of the closed first end 102 is transparent such that a user can view the position of a regulator handle 145 without removing the locking device 100 from its locked position over a regulator 140.

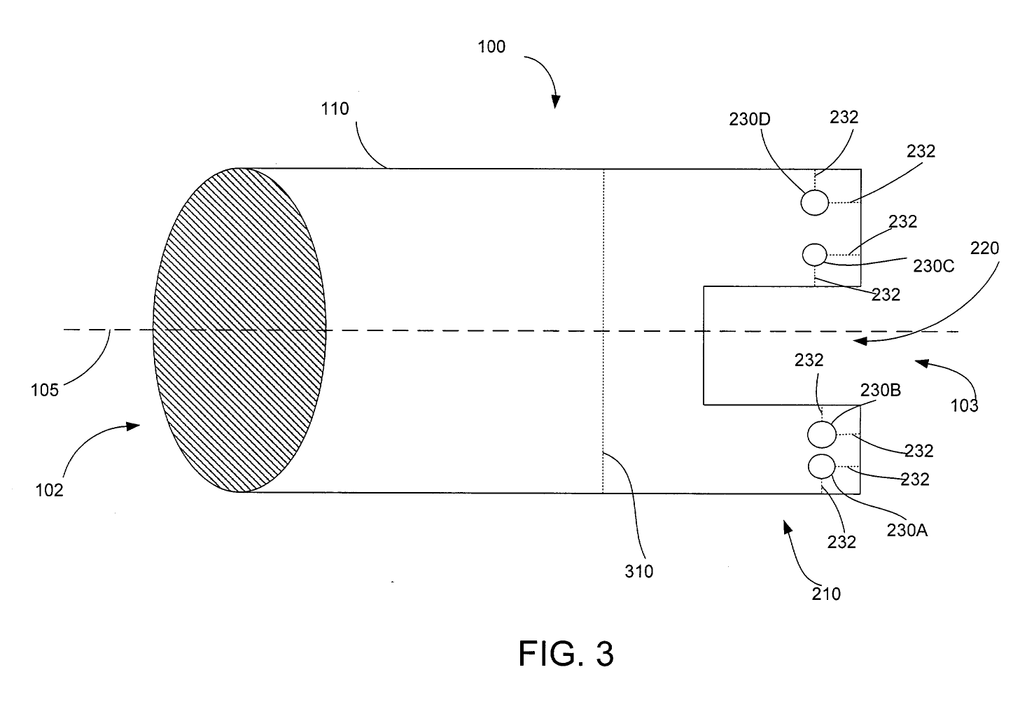

FIG. 3 shows an alternative embodiment of the locking device 100. In this embodiment it is preferable that the hollow member 110 have a ring of perforations 310 around the circumference of the hollow member, preferably at 90 degrees to the longitudinal axis 105. The perforations 310 are typically holes through or almost entirely through the hollow member 110 and selectively spaced apart from each other such that a predetermined amount of torque about the longitudinal axis 105 is required to break the remaining material in the region of the perforations 310. It is preferable that the predetermined torque be an amount that can be generated by a normal adult operator. In use, the ring of perforations 310 allow a user to twist-off or otherwise break the hollow member 110 into two portions, at the ring of perforations 310, thereby, gaining access to the handle 145 of the regulator 140.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A locking device, comprising:
a hollow member, configured to receive at least a handle of a regulator, wherein:
(i) said hollow member is closed on a first end and open on a second end;
(ii) the second end is configured with at least three tabs extending along a longitudinal axis of said hollow member from the second end toward the first end;
(iii) at least two adjacent tabs of said at least three adjacent tabs define a slot configured to receive a gas line coupled to the regulator; and
(iv) each said tab of said at least three tabs defines at least one hole near the second end that is configured for receiving a locking mechanism.

2. The locking device of claim 1, wherein said at least three tabs are made from a breakable material.

3. The locking device of claim 1, further comprising at least four tabs extending along said longitudinal axis from said second end toward said first end; wherein any two adjacent tabs define a slot configured to receive a gas line and wherein each of said tabs define said hole near the second end that is configured for receiving said locking mechanism.

4. The locking device of claim 1, wherein said hollow member is made from a transparent material.

5. The locking device of claim 1, further comprising breakaway zones near said at least one hole configured and dimensioned to direct a breaking of said tab by a user to a desired location.

6. The locking device of claim 1, further comprising a breakaway zone configured and dimensioned on said hollow member such that said hollow member can be reduced to multiple portions to reveal said handle of said regulator without removing said locking mechanism.

7. The locking device of claim 1, wherein said regulator is selected from the group consisting of flow meters, regulators, pressure regulators, gas or air line couplings, fittings, junctions and valves.

8. A locking device, comprising:
a hollow member configured to receive at least a handle of a regulator, wherein:
(i) said hollow member is closed on a first end and open on a second end;
(ii) said second end is configured with a plurality of tabs extending along a longitudinal axis of said hollow member from said second end toward said first end;
(iii) at least two adjacent tabs of said plurality of tabs define a slot configured to receive a gas line coupled to a regulator;
(iv) each said tab of said plurality of tabs defines a hole near said second end configured for receiving a locking mechanism; and
(v) said tabs of said plurality of tabs are constructed of a breakable material.

9. The locking device of claim 8, further comprising at least four tabs extending along said longitudinal axis from said second end toward said first end where any two adjacent said tabs define a slot configured to receive a gas line, and wherein each said tab defines said holes near said second end configured for receiving a shackle of said locking mechanism.

10. The locking device of claim 8, wherein said hollow member is made from a transparent material, such that a user can view said regulator handle when said locking device is in a locked position.

11. The locking device of claim 8, wherein said regulator is selected from the group consisting of flow meters, regulators, pressure regulators, gas or air line couplings, fittings, junctions and valves.

12. A locking device, comprising:
a hollow member configured to receive at least a handle of a regulator, wherein:
(i) said hollow member is closed on a first end and open on a second end;
(ii) said second end is configured with a plurality of tabs extending along a longitudinal axis of said hollow member from said second end toward said first end;
(iii) at least two adjacent tabs of said plurality of tabs define a slot configured to receive a gas line coupled to a regulator;
(iv) each said tab of said plurality of tabs defines a hole near said second end configured for receiving a locking mechanism; and
(v) said hollow member is made from a transparent material, such that a user can view said regulator handle when said locking device is in a locked position.

13. The locking device of claim 12, wherein all or a portion of a tab of said plurality of tabs are made from a breakable material that can be broken by an adult near said hole.

14. The locking device of claim 12, further comprising at least four tabs extending along said longitudinal axis from said second end toward said first end where any two adjacent tabs define a slot configured to receive a gas line, and wherein each of said tabs define said hole near said second end configured for receiving said locking mechanism.

15. The locking device of claim 12, wherein said regulator is selected from the group consisting of flow meters, regulators, pressure regulators, gas or air line couplings, fittings, junctions and valves.

16. A method for selectively confining a regulator, comprising:
engaging a hollow member over a regulator;
selecting the degree of security level by which to lock said hollow member over said regulator;
engaging at least one hole in said hollow member with a locking mechanism; and
locking said locking mechanism.

17. The method of claim 16, further comprising:
breaking said hollow member free from said regulator by applying a force to said hollow member through said locking mechanism such that said hole in said hollow member breaks free thereby releasing said locking mechanism from said hollow member and freeing said regulator from concealment.

18. The method of claim 16, further comprising:
reusing said hollow member by selecting another hole in said hollow member from a plurality of holes for locking said hollow member over said regulator following said breaking said locking mechanism away from said first hole.

19. The method of claim 16, wherein said regulator is selected from the group consisting of flow meters, regulators, pressure regulators, gas or air line couplings, fittings, junctions and valves.
